(19) United States
(12) Patent Application Publication
(10) Pub. No.: US 2003/0031493 A1
(43) Pub. Date: Feb. 13, 2003

(54) Printing/image-setting system

(76) Inventors: Hendrik Frank, Heidelberg (DE); Bernhard Zintzen, Heidelberg (DE)

Correspondence Address: LERNER AND GREENBERG, P.A., Post Office Box 2480, Hollywood, FL, 33022-2480, US

(21) Appl. No.: 10/214,900

(22) Filed: Aug. 7, 2002

Related U.S. Application Data
(60) Provisional application No. 60/322,238, filed on Sep. 14, 2001.

(30) Foreign Application Priority Data
Aug. 7, 2001 (DE) 101 38 773.3

(51) Int. Cl. B41J 3/42

(52) U.S. Cl. 400/74

(57) ABSTRACT

A printing/image-setting system includes an image-setting medium, at least two writing heads and at least two drive units. A control unit is provided for moving the writing heads independently of one another linearly along the medium so as to produce respective partial images resulting in an overall image in the medium, and for controlling setting of the image.

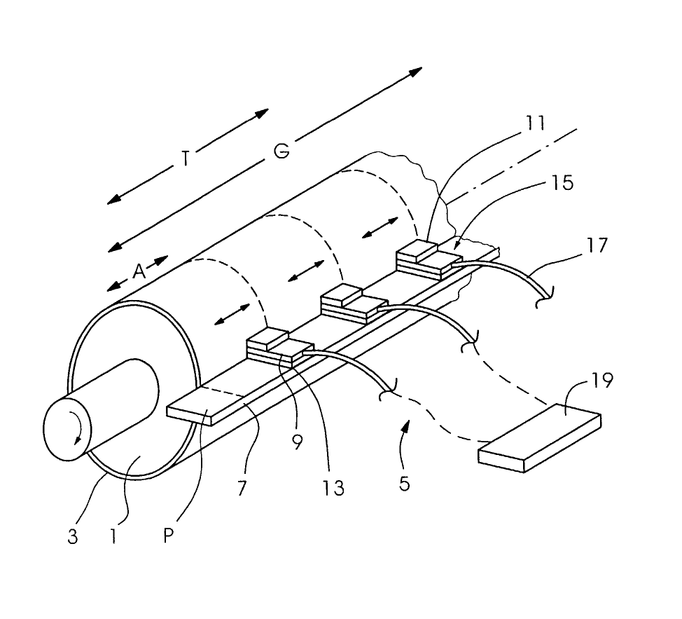

### CROSS-REFERENCE TO RELATED APPLICATION

This application claims the benefit of copending Provisional Application No. 60/322,238, filed Sep. 14, 2001.

### BACKGROUND OF THE INVENTION

1. Field of the Invention

The invention relates to a printing/image-setting system.

An image-setting or imaging system is disclosed in the published European Patent Document EP 1 068 958 A2, wherein a laser-unit writing head is moved in an accurately positioned manner along a line parallel to the axis of a rotating image-setting drum by a spindle drive and a stepping motor. In this regard, exact positioning and control of the movement of the writing head is carried out with the aid of various sensor units.

In addition, image-setting or imaging systems with a linear motor are generally known from U.K. Patent Application GB 2 050 947 A and U.S. Pat. No. 4,631,432.

Also generally known are drive concepts with recirculating ball screws or spindles with stepping or servo motors. Rotational movement is converted via the recirculating ball screws into a linear movement. In this regard, the screw drives a carriage which is guided on linear guides, the image-setting unit being mounted on the carriage. Heretofore known constructions differ in the type of image-setting or imaging strategy, but not in the type of drive. When the recirculating ball screw is used, only one carriage can be moved. All channels and laser diodes, respectively, of the laser head are mounted on this carriage. In the event of a failure of an individual channel, after the failed channel has been detected, a new image-setting operation must be started.

The existing drive concepts for the heretofore known laser image-setting or imaging units in equipment for setting digital images on printing plates exhibit a reduction in the speed of the image-setting or imaging process in the event of a failure of individual laser diodes, the level or extent of slowing depending upon the image-setting strategy that is being used.

2. Summary of the Invention

It is accordingly an object of the invention to provide a printing/image-setting or imaging system having an increased flexibility and availability over heretofore known systems of this general type.

With the foregoing and other objects in view, there is provided, in accordance with the invention, a printing/image-setting system, comprising an image-setting medium, at least two writing heads and at least two drive units. A control unit is provided for moving the writing heads independently of one another linearly along the medium so as to produce respective partial images resulting in an overall image in the medium, and controlling setting of the image.

In accordance with another feature of the invention, the control unit serves for assigning image-setting areas of varying width to the writing heads for setting the image.

In accordance with a further feature of the invention, the control unit serves for assigning image-setting areas of like width to the writing heads for setting the image.

In accordance with an added feature of the invention, upon an occurrence of a defect in one of the writing heads, the control unit serves for changing an image-setting algorithm and implementing setting an image from the defective writing head by at least one writing head remaining without defect.

In accordance with an additional feature of the invention, one of the drive units has a parking area laterally outside an overall image-setting area, and the control unit serves for moving a defective printing head, which is disposed laterally outside, into the parking area.

In accordance with yet another feature of the invention, upon an occurrence of a defect in one of the writing heads, the control unit serves for changing an image-setting algorithm and re-dividing an overall image-setting area for the at least one writing head remaining without defect.

In accordance with yet a further feature of the invention, the writing heads are guidable on a single guide.

In accordance with yet an added feature of the invention, the control unit serves for assigning only one sub-area of an overall image-setting width to the writing heads for setting an image.

In accordance with yet an additional feature of the invention, the drive unit is realized by a linear drive with a linear guide and a linear motor.

In accordance with a concomitant feature of the invention, a plurality of image-setting plates is disposed along the image-setting medium, an overall image being producible on at least one of the image-setting plates.

The printing/image-setting system according to the invention is suitable, in particular, for printing machines or plate image-setting or imaging appliances. The invention permits flexible and individual movement of the individual printing heads or laser modules. At the same time, a plurality of carriages can be moved independently of one another on one or more rails belonging to a linear drive, or a plurality of screws. As a result of the use of linear motors as a direct drive and a linear encoder, the resumption of an aborted image-setting operation is possible, because the possibility then exists of being able to move a second time specifically to positions on the plate.

According to a preferred embodiment, provision is made for the control unit to assign only one sub-area of the overall or entire image-setting width to the writing heads for setting an image. As a result, the image-setting system can be adapted optimally for setting images on smaller image-setting plates.

Provision is advantageously made, in the event of a defect in one of the writing heads, for the control unit to change the image-setting algorithm and to re-divide the overall image-setting area for the remaining, intact writing heads. As a result, a high degree of flexibility of the image-setting unit is made possible, in the event of a fault.

In order to be able to avoid complicated dismantling of a defective laser unit, provision is made, in particular, for the drive unit to have a parking area laterally outside the overall image-setting area, and for the control unit to move a defective printing head, which is disposed laterally outside, into the parking area.

According to a preferred embodiment of the system according to the invention, the writing heads are guided on a single guide, in order, in a manner distinct from a multiple guide system, to be able to implement a simple and cost-effective construction.

The drive unit that is used is preferably a linear drive with a linear guide and a linear motor, because the linear drive is advantageous with respect to precision and speed when compared with a screw or spindle drive which is alternatively possible as an example.

Hereinafter, an exemplary embodiment of the image-setting system according to the invention is described.

Other features which are considered as characteristic for the invention are set forth in the appended claims.

Although the invention is illustrated and described herein as embodied in a printing/image-setting system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying single FIGURE of a drawing.

### BRIEF DESCRIPTION OF THE DRAWINGS

The FIGURE of the drawing is a fragmentary, diagrammatic perspective and schematic view of the image-setting or imaging system according to the invention.

### DESCRIPTION OF THE PREFERRED EMBODIMENTS

Referring now in detail to the single FIGURE of the drawing, there is seen an image-setting system for a DI (Direct Imaging) application, having a plate cylinder 1 with an image-setting plate 3 clamped thereon. Assigned to the plate cylinder 1 is an image-setting unit 5 having a linear drive arrangement with a plurality of linear motors 9 guided on a linear guide 7, by which a plurality of mutually independently driven drive units are implemented. In this regard, the linear guide 7 forms an unenergized secondary part of the drive and extends over the travel width of the image-setting system. The linear motors 9 form the primary part of the linear drive. The linear motors 9 are constructed as stepping motors in accordance with the reluctance principle. Each of the linear motors 9, respectively, together with a laser module 11, is mounted on a respective carriage 13 and forms a linear module 15. Each linear module 15 therefore has only one laser module 11, which is formed of a laser line with, for example, 50 channels and laser diodes, respectively. The linear module 15 is supplied with power by a cable dragger 17. In addition, data transfer between the laser module 11 and a control unit 19 belonging to the image-setting or imaging system is carried out via the cable dragger 17. The control unit 19 controls the independent movements of the linear modules 15 and the setting of an image by the four laser modules 11.

During the setting of an image, depending upon the image data, an overall image-setting area G is divided up, for example, into four image-setting areas A of equal width, which requires four linear modules 15. An appropriate image-setting algorithm is provided for each of the laser modules 11. Alternatively, it is also possible to divide up the entire image-setting area G into image-setting areas of different widths, if this offers a speed advantage in the case of the image data which are provided. If an image-setting plate 3 of lesser width is to have an image set thereon, the entire or overall image-setting area G can be reduced to a corresponding image-setting subarea T. The control unit 19 then positions the four laser modules 11 with correspondingly close spacing in the reduced area T. Adaptation of the image-setting unit 5 to the plate size is therefore carried out, so that an increase in the image-setting speed is possible.

A further possible use for image-setting is in rotary newspaper printing machines. In this case, it is usual for a plurality of separate printing plates to be mounted beside one another on the circumference of a cylinder. In order to produce local editions or in case of defects, often individual plates on the cylinder are replaced. In such a case, the image-setting device according to the invention can be employed advantageously. That is because, in such a case, the overall image-setting area G extends over the entire cylinder width and over more than one plate. In this regard, each plate usually represents an image that is independent from the adjacent plate. When an individual plate is replaced for a plate without a set image, it is possible then for all the image-setting units to be employed in the image-setting subarea T in such a way that an image can be set on this plate in a time-optimal manner. To this extent, the writing heads are therefore controlled so that each of the writing heads produces a partial image which, on this plate, results in an overall image.

If a diode of a diode line or an entire laser module 11 should fail, the control unit 19 causes the following to occur, depending upon the printing conditions which are present:

If the defective laser module is disposed at the edge, this laser module is moved into the parking area P of the linear guide; if the defective laser module lies between the other modules, this laser module, respectively, is moved outside the current image-setting area of the physically adjacent laser modules.

Simultaneously, the overall image-setting area is divided uniformly or in another suitable manner over the remaining three laser modules, and appropriately changed image-setting algorithms and re-sorted image-setting data are provided by the control unit.

It is also possible for only a reduction in the image-setting area of the defective laser module to be effected, if the laser module is at least partially serviceable.

An adjacent laser module takes over the image-setting area of the defective laser module completely. The setting of an image by the remaining laser modules remains unchanged.

As an alternative to the exemplary embodiment described hereinbefore, motors operating in accordance with the synchronous or asynchronous principle could also be used. If the stepping motor is used, depending upon the system specifications, it is possible to dispense with a position measuring system (not illustrated); this is because the stepping-motor control system is able to move under control to the positions desired for the linear modules 15 by counting the steps travelled by the respective linear motor. If asynchronous or synchronous motors were to be used, a position measuring system would be used for the position control and as a motor feedback system (not shown). The position transmitters supply the motor control system with the exact positions of the various laser modules 11, so that the exact positions of the laser modules 11 relative to the plate 3 or to the plate cylinder 1 can be regulated via positional control of the individual linear motors 9. In this regard, the plate may rest or else rotate while clamped on the cylinder.

In a further embodiment, the cable dragger can also be replaced by power transmission units operating without contact (e.g., inductive, capacitive). In addition, the data transmission from the laser module 11 to the control unit 19 can be carried out via specific control lines or without contact (not shown).

As an alternative to the aforedescribed embodiment having the wide secondary part and linear guide 7, respectively, extending at least approximately over the length of the plate cylinder 3, a non-illustrated conventional, distributed linear motor could also be used. In the case of the latter, the secondary part 7 is constructed segmented over the entire width and drives a respective primary part 9 for each segment. In this regard, the primary part 9 and the laser module 11 are likewise, respectively, mounted on a carriage. In this regard, the specific motor principle likewise plays no part in the system.

We claim:

1. A printing/image-setting system, comprising an image-setting medium, at least two writing heads, at least two drive units, and a control unit for moving said writing heads independently of one another linearly along the medium for producing respective partial images resulting in an overall image in said medium, and for controlling setting of the image.

2. The printing/image-setting system according to claim 1, wherein said control unit serves for assigning image-setting areas of varying width to said writing heads for setting the image.

3. The printing/image-setting system according to claim 1, wherein said control unit serves for assigning image-setting areas of like width to said writing heads for setting the image.

4. The printing/image-setting system according to claim 1, wherein, upon an occurrence of a defect in one of said writing heads, said control unit serves for changing an image-setting algorithm and implementing setting of an image from the defective writing head by at least one writing head remaining without defect.

5. The printing/image-setting system according to claim 1, wherein one of said drive units has a parking area laterally outside an overall image-setting area, and said control unit serves for moving a defective printing head, being disposed laterally outside, into said parking area.

6. The printing/image-setting system according to claim 1, wherein, upon an occurrence of a defect in one of said writing heads, said control unit serves for changing an image-setting algorithm and re-dividing an overall image-setting area for the writing heads remaining without defect.

7. The printing/image-setting system according to claim 1, wherein said writing heads are only two in number, and wherein, upon an occurrence of a defect in one of said writing heads, said control unit serves for changing an image-setting algorithm and calculating an overall image-setting area for the writing head remaining without defect.

8. The printing/image-setting system according to claim 1, wherein said writing heads are to be guided on a single guide.

9. The printing/image-setting system according to claim 1, wherein said control unit serves for assigning only one sub-area of an overall image-setting width to said writing heads for setting an image.

10. The printing/image-setting system according to claim 1, wherein said drive unit is a linear drive with a linear guide and a linear motor.

11. The printing/image-setting system according to claim 1, wherein a plurality of image-setting plates is disposed along said image-setting medium, and an overall image is to be produced on at least one of said image setting plates.
